(19) United States
(12) Patent Application Publication
(10) Pub. No.: US 2025/0084812 A1
(43) Pub. Date: Mar. 13, 2025

(54) Multipurpose four-piece air delivery system for internal combustion engines

(71) Applicants: Jonathan Bitler, Weeki Wachee, FL (US); Ryan Harper, Satellite Beach, FL (US)

(72) Inventors: Jonathan Bitler, Weeki Wachee, FL (US); Ryan Harper, Satellite Beach, FL (US)

(21) Appl. No.: 18/465,354

(22) Filed: Sep. 12, 2023

(51) Int. Cl. F02M 35/10

(52) U.S. Cl. CPC F02M 35/10157; F02M 35/10196; F02M 35/10327; F02M 35/10367; F02M 35/10091

(57) ABSTRACT

A four-piece billet aluminum device used to deliver compressed air into an internal combustion engine through a carburetor. An inlet delivers forced air from a compressor to the outlet fastened and sealed to the top of the carburetor to give equal distribution to the internal combustion engine. The device can also be used for draw through, naturally aspirated and nitrous assisted internal combustion engines that are prioritizing fresh air to the carburetor. The multipurpose four-piece billet air delivery system has four ports for monitoring air speed, intake air temperature, vacuum/manifold atmospheric pressures, and a port for force induction setups to vacuum/boost reference a fuel pressure regulator to meet fuel demands. There is an additional opening that requires an atmospheric reverse pressure disc to protect an internal combustion engine that is turbocharged, supercharged or nitrous equipped from further damage if it were to have a major backfire or reversed pressure.

### CROSS-REFERENCE TO RELATED APPLICATIONS

This application claims the benefit of U.S. Provisional Application No. 63/375,520, filed Sep. 13, 2022.

### PRIOR ART

### References Cited

U.S. Pat. No. 3,224,174 A 12/1965 Erbstoesser
U.S. Pat. No. 3,347,028 A 10/1967 Erbstoesser
U.S. Pat. No. 3,484,817 A 12/1969 Wood
U.S. Pat. No. 6,886,526 B2 05/2005 Bishop
U.S. Pat. No. 7,107,962 B1 09/2006 Spies et al.
U.S. Pat. No. D582,433 S 12/2008 Rosenbaum

### BACKGROUND OF THE INVENTION

The invention relates to prioritizing more air into an internal combustion engine thereby creating more horsepower by delivering more air (compressed air to speed up engine revolutions per minute or RPM) from a supercharger, turbocharger or fresh air from a naturally aspirated or nitrous oxide assisted internal combustion engine. Prioritizing more air is paramount due to the increased level of oxygen needed to mix with the fuel, which provides a proper air fuel ratio for an internal combustion engine. The air intake device forces air and will direct the air to the carburetor where it is needed while boost referencing the fuel pressure regulator to increase fuel demand for a complete and clean fuel burn. This increased air flow allows more fuel to be added which makes more horsepower at extreme engine loads while balancing the internal combustion engine. It is advantageous to measure air intake temperatures, air speed, vacuum/manifold atmospheric pressure and fuel pressure referencing in order to properly tune the internal combustion engine for more horsepower. Due to the high levels of pressures in these systems sometimes engine failures can take place when these units of measure are inaccurate. An atmospheric reverse pressure disc would be beneficial to protect any reversion and discharge of the engine.

### SUMMARY OF THE INVENTION

The Multipurpose four-piece billet air delivery system utilizes a 10-degree shift forward at the base where it is mounted and sealed on both ends with an O-ring to the top of the carburetor and a dual seal at the appended inlet from the compressor to help equal distribution of air flow under compressed air or draw through naturally aspirated/nitrous assisted internal combustion engines. The advantages of this design allow for better left to right air distribution of air flow directed in the internal combustion engine with no air leaks along with the four ports for monitoring air speed, intake air temperature, vacuum/manifold atmospheric pressures and also the extra port for force induction setups to vacuum/boost a fuel pressure regulator to meet fuel demands when atmospheric conditions raise 1:1 ratio. Additionally, there is an opening that requires a safety pressure relief or burst disc on the side of the unit to protect an internal combustion engine that is turbocharged, supercharged or nitrous equipped from further damage if it were to have a significant pressure reversion.

### BRIEF DESCRIPTION OF DRAWINGS

The invention will now be illustrated with respect to the following drawings illustrating embodiments of the invention in which:

FIG. 1 is a perspective of one half of the multipurpose air delivery system that houses the atmospheric pressure relief or burst disc and two of the four metering ports.

FIG. 2 is the other half of the multipurpose air delivery system which house the remaining two air monitoring ports.

FIG. 3 is a rear-view perspective of FIG. 1 that shows the monitoring ports and atmospheric pressure relief or burst disc.

FIG. 4 is a side view perspective of FIG. 1.

FIG. 5 is the inside view of FIG. 2 that shows the optional dimple porting machining,

FIG. 6 is an underside perspective of FIG. 2 that shows the locations where the device is secured to the carburetor.

FIG. 7 is a front view of the dual sealed coupler that affixes to the inlet of FIG. 1 and FIG. 2 when they are joined together.

### DETAILED DESCRIPTION OF THE INVENTION

Referring to FIGS. 1 and 2, illustrated are two halves of the multipurpose air delivery device, referred to as the body (13) which is constructed of 6061 billet aluminum with an option to have a hard anodized finish to strengthen the material. The two pieces of the body (13) are joined together by stainless steel or titanium hardware screws (2) and two O-rings (14) (15) that join the two halves together to seal the unit from potential air leaks when under pressure. It has a dual seal inlet coupler FIG. 7 (12) that is attached to the inlet (4) by four titanium or stainless screws (9) and the inlet (4) (12) is then attached to a supercharger, turbocharger or air duct tube and an outlet (3) that fastens to the top of a carburetor by 4 titanium or stainless hardware FIG. 6. (8). FIGS. 1 and 2 house the monitoring ports (10) and Figure one contains the housing for the revere pressure disc assembly (5).

Compressed air coming from the supercharger, turbocharger or air duct enters the inlet (4) (12) and is forced or drawn through the multipurpose air delivery system and enters the carburetor. It is necessary for an internal combustion engine to have air that is prioritized to the carburetor to meet the fuel demands in high horsepower situations. This ensures the mixture of fuel and air burns clean during extreme loads.

There are four monitoring ports (10) located in the center of the back of the multipurpose air delivery system. These ports can be plugged if the consumer chooses not to use them in a naturally aspirated setting, or sensors can be added to measure air cubic feet per meter, air temperature, manifold atmospheric pressure and air speed. One port of the three is intended to be used as a boost reference for a fuel pressure regulator to make the fuel mixture and air mixture raise to a 1:1 ratio.

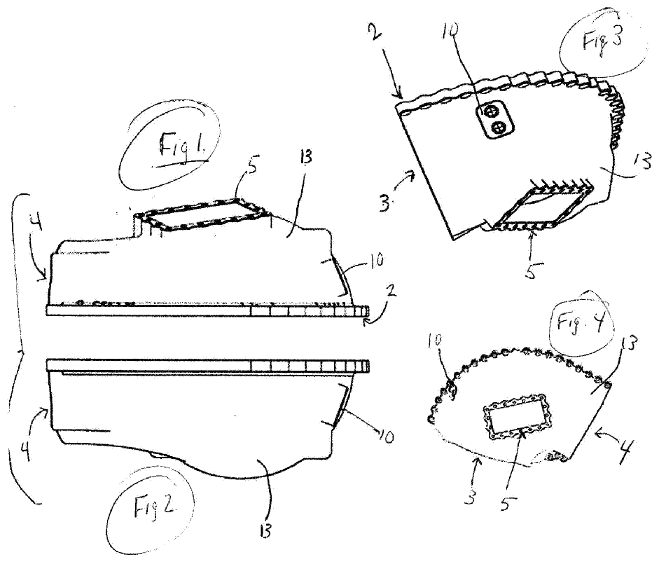

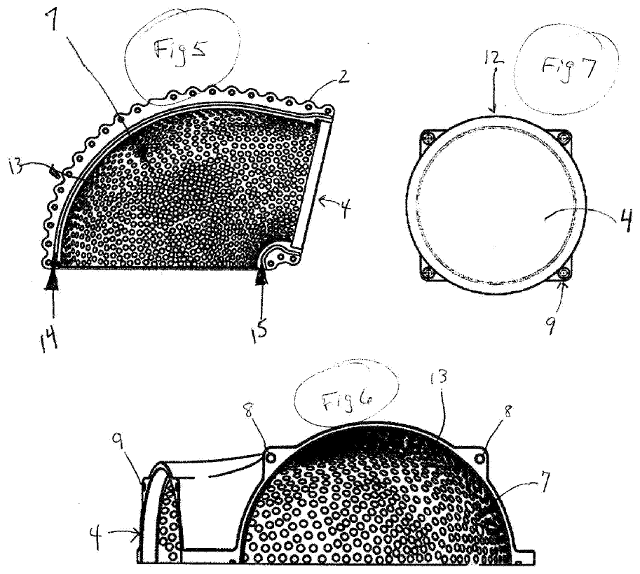

FIGS. 1, 3 and 4 (5) shows a housing for a pressure relief burst plate that is attached by 18 titanium or stainless-steel screws. The burst plate or pressure relief disc (5) is necessary to be added to the housing area (5). It is a unique safety feature addition to the invention that is intended to keep the charge pipe or air duct from blowing off the internal combustion engine by allowing the pressure to be relieved or forced out through the disc (5). There is a potential for a reverse pressure situation when the ignition system malfunctions, or other operator errors exist that cause the engine to backfire causing pressure to come back into the intake manifold and up through the carburetor and out through the multipurpose air delivery system.

FIGS. 5 and 6 (7) illustrates the optional dimple porting on the inside surface of the body (13) that allows the compressed or drawn air to be centered in the port as it goes into the top of the carburetor. It is intended to correct the turbulence of the air flow and direct it straight into the carburetor through the outlet (4).

1. A four-piece air delivery device constructed of billet 6061 aluminum used to deliver air from a turbocharger, supercharger or can be used to prioritize air to a naturally aspirated nitrous oxide assisted internal combustion engines through the carburetor.

2. The four-piece air delivery device of claim 1 further comprising a safety pressure burst plate.

3. The four-piece air delivery device of claim 1 further comprising four monitoring ports intended to be used to attach sensors to monitor the air inside the air delivery system for purposes of tuning the engine.

4. The four-piece air delivery device of claim 1 further comprising optional dimple port machining on the inside of the air delivery system which corrects the turbulence of the air flow and direct it straight into the carburetor through the outlet.
